(19) United States
(12) Patent Application Publication
(10) Pub. No.: US 2013/0056287 A1
(43) Pub. Date: Mar. 7, 2013

(54) THREE-WHEELED ELECTRIC VEHICLE

(71) Applicants: Young jin PARK, Daejeon (KR); Youn-Sik PARK, Daejeon (KR); Jae Seok YOU, Chungju-si (KR)

(72) Inventors: Young jin PARK, Daejeon (KR); Youn-Sik PARK, Daejeon (KR); Jae Seok YOU, Chungju-si (KR)

(73) Assignee: Korea Advanced Institute of Science and Technology, Daejeon (KR)

(21) Appl. No.: 13/602,631

(22) Filed: Sep. 4, 2012

(30) Foreign Application Priority Data
Sep. 1, 2011 (KR) 10-2011-0088277

(51) Int. Cl. B62D 5/04; B62D 11/04; B62D 61/06

(52) U.S. Cl. 180/6.28; 180/216; 180/6.24

(57) ABSTRACT

Provided is a three-wheeled electric vehicle. The three-wheeled electric vehicle includes: a front left wheel disposed on a front left portion of the three-wheeled electric vehicle; a front right wheel disposed on a front right portion of the three-wheeled electric vehicle; a rear wheel disposed on a rear center portion of the three-wheeled electric vehicle; a first driving motor configured to transfer a driving power to the front left wheel; a second driving motor configured to transfer a driving power to the front right wheel; and a steering motor configured to transfer a steering power to the rear wheel.

### CROSS-REFERENCE TO RELATED APPLICATION

This application claims priority to and the benefit of Korean Patent Application No. 2011-88277, filed on Sep. 1, 2011, the disclosure of which is incorporated herein by reference in its entirety.

### BACKGROUND

1. Field of the Invention

The present invention relates to a three-wheeled electric vehicle.

2. Discussion of Related Art

In general, an electric vehicle drives a motor by usually using an electric power of a battery to generate a driving power, and drives the motor by converting chemical energy stored in a charged battery into electric energy. Although electric vehicles have not been commercialized due to heavy weight of a battery and time taken to charge the battery, recently electric vehicles have been developed again because of severe pollution problem. An electric vehicle that moves by using electricity as a driving power does not discharge exhaust gas and cause environmental pollution, and generates less noise.

Recently, a three-wheeled electric vehicle is being actively developed since the three-wheeled electric vehicle is economical compared with a four-wheeled electric vehicle while driving. Korean Patent Application No. 2010-0013052 discloses a technology regarding a three-wheeled electric vehicle. The technology disclosed in the above document relates to a three-wheeled electric scooter including a system configured to steer using a steering angle only by front wheels, wherein the three-wheeled electric scooter may run only by using a pedal and an electric motor.

However, the above conventional art still needs improvement. That is, since the three-wheeled electric vehicle according to the conventional art provides a steering power only by front wheels, the three-wheeled electric vehicle is in unstable state. In addition, posture of the vehicle is controlled only by brakes on left and right sides of the front wheels and a steering angle, and thus, passengers may feel insecurity while driving the vehicle.

### SUMMARY OF THE INVENTION

The present invention is directed to a three-wheeled electric vehicle that is improved from a conventional three-wheeled electric vehicle.

According to an aspect of the present invention, there is provided a three-wheeled electric vehicle including: a front left wheel disposed on a front left portion of the three-wheeled electric vehicle; a front right wheel disposed on a front right portion of the three-wheeled electric vehicle; a rear wheel disposed on a rear center portion of the three-wheeled electric vehicle; a first driving motor configured to transfer a driving power to the front left wheel; a second driving motor configured to transfer a driving power to the front right wheel; and a steering motor configured to transfer a steering power to the rear wheel.

The first driving motor and the second driving motor may provide the front left wheel and the front right wheel with different torques from each other to provide a skid steering function.

The steering motor may adjust an angle of the rear wheel to provide an Ackermann steering function.

The three-wheeled electric vehicle may further include: a steering wheel; and a calculator configured to generate a first driving motor controlling signal, a second driving motor controlling signal, and a steering motor controlling signal that are transferred respectively to the first driving motor, the second driving motor, and the steering motor, according to a rotating angle of the steering wheel.

When the steering wheel is rotated in a counter-clockwise direction, the calculator may generate the steering motor controlling signal allowing a front portion of the rear wheel to rotate toward a right side in a proceeding direction of the three-wheeled electric vehicle, and may generate the first driving motor controlling signal and the second driving motor controlling signal so that a torque of the front right wheel is greater than a torque of the front left wheel.

When the steering wheel is rotated in a clockwise direction, the calculator may generate the steering motor controlling signal allowing a front portion of the rear wheel to rotate toward a left side in a proceeding direction of the three-wheeled electric vehicle, and may generate the first driving motor controlling signal and the second driving motor controlling signal so that a torque of the front right wheel is less than a torque of the front left wheel.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a planar view schematically showing a structure of a driving motor and a steering motor device for a three-wheeled electric vehicle according to an embodiment of the present invention; and

FIG. 2 is a side view schematically showing structure of the driving motor and the steering motor device for a three-wheeled electric vehicle according to an embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Hereinafter, a three-wheeled electric vehicle according to the present invention in which the above objects may be specifically realized will be described in more detail. Further, in a description of an embodiment of the present invention, same elements are denoted by the same reference numerals or names, and a detailed description thereof will be omitted.

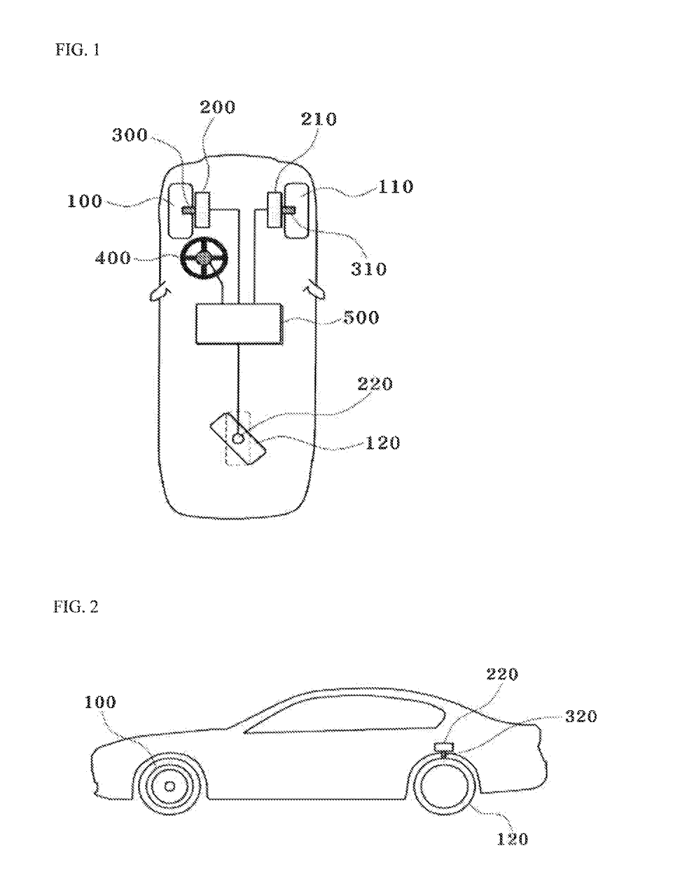

FIG. 1 is a planar view of a three-wheeled electric vehicle according to an embodiment of the present invention. Referring to FIG. 1, the three-wheeled electric vehicle includes a front left wheel 100, a front right wheel 110, a rear wheel 120, a first driving motor 200, a second driving motor 210, a steering motor 220, a steering wheel 400, a first driving axis 300, a second driving axis 310, a steering axis 320 (refer to FIG. 2), and a calculator 500.

Referring to FIG. 1, the front left wheel 100 is disposed on a front left portion of the vehicle, the front right wheel 110 is disposed on a front right portion of the vehicle, and the rear wheel 120 is disposed on a rear center portion of the vehicle. The first driving motor 200 transfers a driving power to the front left wheel 100, the second driving motor 210 transfers a driving power to the front right wheel 110, and the steering motor 220 transfers a steering power to the rear wheel 120.

The first driving axis 300 connects the front left wheel 100 to the first driving motor 200. The first driving axis 300 transfers a rotary driving power generated by the first driving motor 200 to the front left wheel 100. The second driving axis 310 connects the front right wheel 110 to the second driving motor 210. The second driving axis 310 transfers a rotary driving power generated by the second driving motor 210 to the front right wheel 110. The steering axis 320 (refer to FIG. 2) connects the steering motor 220 to the rear wheel 120. The steering axis 320 (refer to FIG. 2) rotates the rear wheel 120 to a left side or a right side of a proceeding direction of the vehicle according to rotation of the steering motor 220.

The steering wheel 400 may be disposed on one of a front left side and a front right side of the vehicle, and a driver directly manipulates the steering wheel 400 to move the rear wheel 120 in any direction. A signal corresponding to a rotating angle of the steering wheel 400 is transferred to the calculator 500, and the calculator 500 generates a first driving motor controlling signal, a second driving motor controlling signal, and a steering motor controlling signal according to the transferred signal. The generated first driving motor controlling signal, the second driving motor controlling signal, and the steering motor controlling signal are transferred respectively to the first driving motor 200, the second driving motor 210, and the steering motor 220.

For example, when the driver rotates the steering wheel 400 in a counter-clockwise direction, the calculator 500 generates a steering motor controlling signal allowing a front portion of the rear wheel 120 to rotate toward the right side of the proceeding direction of the vehicle, and generates a first driving motor controlling signal and a second driving motor controlling signal so that a torque of the front right wheel 110 is greater than a torque of the front left wheel 100. In addition, when the driver rotates the steering wheel 400 in a clockwise direction, the calculator 500 generates a steering motor controlling signal allowing the front portion of the rear wheel 120 to rotate toward the left side of the proceeding direction of the vehicle, and generates a first driving motor controlling signal and a second driving motor controlling signal so that a torque of the front right wheel 110 is greater than a torque of the front left wheel 100.

The first driving motor 200 and the second driving motor 210 may provide a skid steering function by providing the front left wheel 100 and the front right wheel 110 with different torques from each other. For example, when the steering wheel 400 rotates to the left direction, the torque of the front right wheel 110 may be greater than the torque of the front left wheel 100. As another example, when the steering wheel 400 rotates to the right direction, the torque of the front left wheel 100 may be greater than the torque of the front right wheel 110. The steering motor 220 may provide an Ackermann steering function by adjusting an angle of the rear wheel 120.

FIG. 2 is a side view of the three-wheeled electric vehicle according to the embodiment of the present invention. The steering axis 320 of the steering motor 220 disposed on the rear wheel 120 may be connected to the rear wheel 120 so as to steer the rear wheel 120. For example, the steering motor 220 on the rear wheel 120 is connected perpendicularly to the rear wheel 120; however, the steering motor 220 of the rear wheel 120 may be connected obliquely to the rear wheel 120, differently from the drawing.

According to the three-wheeled electric vehicle of the present invention, the driving power is transferred to the front wheels that are disposed on the front left and right portions of the vehicle and the steering power is transferred to the rear wheel disposed on the rear portion of the vehicle, and accordingly, steering property and stability of the three-wheeled electric vehicle may be improved, and moreover, posture of the three-wheeled electric vehicle may be controlled more safely.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A three-wheeled electric vehicle comprising:
a front left wheel disposed on a front left portion of the three-wheeled electric vehicle;
a front right wheel disposed on a front right portion of the three-wheeled electric vehicle;
a rear wheel disposed on a rear center portion of the three-wheeled electric vehicle;
a first driving motor configured to transfer a driving power to the front left wheel;
a second driving motor configured to transfer a driving power to the front right wheel; and
a steering motor configured to transfer a steering power to the rear wheel.

2. The three-wheeled electric vehicle of claim 1, wherein the first driving motor and the second driving motor provide the front left wheel and the front right wheel with different torques from each other to provide a skid steering function.

3. The three-wheeled electric vehicle of claim 1, wherein the steering motor adjusts an angle of the rear wheel to provide an Ackermann steering function.

4. The three-wheeled electric vehicle of claim 1, further comprising:
a steering wheel; and
a calculator configured to generate a first driving motor controlling signal, a second driving motor controlling signal, and a steering motor controlling signal that are transferred respectively to the first driving motor, the second driving motor, and the steering motor, according to a rotating angle of the steering wheel.

5. The three-wheeled electric vehicle of claim 4, wherein when the steering wheel is rotated in a counter-clockwise direction, the calculator generates the steering motor controlling signal allowing a front portion of the rear wheel to rotate toward a right side in a proceeding direction of the three-wheeled electric vehicle, and generates the first driving motor controlling signal and the second driving motor controlling signal so that a torque of the front right wheel is greater than a torque of the front left wheel.

6. The three-wheeled electric vehicle of claim 4, wherein when the steering wheel is rotated in a clockwise direction, the calculator generates the steering motor controlling signal allowing a front portion of the rear wheel to rotate toward a left side in a proceeding direction of the three-wheeled electric vehicle, and generates the first driving motor controlling signal and the second driving motor controlling signal so that a torque of the front right wheel is less than a torque of the front left wheel.
